(19) United States
(12) Patent Application Publication
(10) Pub. No.: US 2019/0220795 A1
(43) Pub. Date: Jul. 18, 2019

(54) METHODS AND SYSTEMS FOR ANALYZING AND ENABLING SAFETY PROCEDURES AND RULES

(71) Applicant: Terra Millennium Corporation, Salt Lake City, UT (US)

(72) Inventors: Robert S. Fox, North Salt Lake, UT (US); Leta M. Howard, Cottonwood Heights, UT (US)

(21) Appl. No.: 16/249,825

(22) Filed: Jan. 16, 2019

Related U.S. Application Data
(60) Provisional application No. 62/619,059, filed on Jan. 18, 2018.

(51) Int. Cl. G06Q 10/06; H04L 12/58; G09B 5/06

(52) U.S. Cl. CPC G06Q 10/063112; G06Q 50/265; G09B 5/06; H04L 51/16

(57) ABSTRACT

Methods, systems, and devices for real-time analytics are described. One method may include receiving a set of data related to an environment and a set of individuals in the environment, and determining a condition of the environment and the set of individuals in the environment based on a real-time analysis of the received set of data. The condition may include a safety concern identified by a majority of the set of individuals. The method may further include generating a real-time snapshot report including the safety concern associated with the condition of the environment and the set of individuals in the environment, and providing the report for display.

### CROSS REFERENCES

The present Application for Patent claims priority to U.S. Provisional Patent Application No. 62/619,059 by Fox, et al., entitled “Methods and Systems for Analyzing and Enabling Safety Procedures and Rules,” filed Jan. 18, 2018, assigned to the assignee hereof.

### BACKGROUND

Safety issues are at the forefront of consideration at all worksites, and the safety of worksites may be governed by regulatory bodies such as the Occupational Safety and Health Administration (OSHA), the Mine Safety and Health Administration (MSHA), and other laws and regulations. In additional engineering and development companies hired to manage the development of worksites may also have individual company safety procedures and policies. Often, safety concerns, education, rules, and the like, may be reactionary instead of proactive. That is, many companies and laws develop policies, procedures, and consequences based on safety issues which have already occurred. A need to develop a proactive system and methodology for identifying real-time, risk-prone behaviors addressing those behaviors through peer-to-peer acknowledgement, training, and other educational mediums before those behaviors culminate in an incident.

### SUMMARY

The described techniques relate to improved methods, systems, devices, and apparatuses that support analyzing and enabling safety procedures and rules. Generally, the described techniques provide for obtaining or otherwise determining information regarding safety issues on a worksite in real time, providing analytical feedback regarding the safety issues, providing educational information to employees, providing feedback to employees, and other safety and work improvements. More specifically, the following relates to receiving a set of data related to a worksite and a set of workers at the worksite, determining a condition of the worksite (e.g., a safety-related condition, a safety concern identified by a majority of the set of individuals) and/or the set of workers in the environment based on a real-time analysis of the received set of data, generating a report based on the condition, where the report includes the safety concern among other data related to the worksite/workers, and providing the report for display to an appropriate individual (e.g., a foreman).

A method of real-time analytics, the method being performed by one or more computing devices including at least one processor, the method including is described. The method may include receiving a set of data related to an environment and a set of individuals in the environment, determining a condition of the environment and the set of individuals in the environment based on a real-time analysis of the received set of data, where the condition includes a safety concern identified by a majority of the set of individuals, generating a real-time snapshot report based on the determining, where the real-time snapshot report includes the safety concern associated with the condition of the environment and the set of individuals in the environment, and providing the real-time snapshot report for display.

An apparatus for real-time analytics, the method being performed by one or more computing devices including at least one processor, the method including is described. The apparatus may include a processor, memory in electronic communication with the processor, and instructions stored in the memory. The instructions may be executable by the processor to cause the apparatus to receive a set of data related to an environment and a set of individuals in the environment, determine a condition of the environment and the set of individuals in the environment based on a real-time analysis of the received set of data, where the condition includes a safety concern identified by a majority of the set of individuals, generate a real-time snapshot report based on the determining, where the real-time snapshot report includes the safety concern associated with the condition of the environment and the set of individuals in the environment, and provide the real-time snapshot report for display.

Another apparatus for real-time analytics, the method being performed by one or more computing devices including at least one processor, the method including is described. The apparatus may include means for receiving a set of data related to an environment and a set of individuals in the environment, determining a condition of the environment and the set of individuals in the environment based on a real-time analysis of the received set of data, where the condition includes a safety concern identified by a majority of the set of individuals, generating a real-time snapshot report based on the determining, where the real-time snapshot report includes the safety concern associated with the condition of the environment and the set of individuals in the environment, and providing the real-time snapshot report for display.

A non-transitory computer-readable medium storing code for real-time analytics, the method being performed by one or more computing devices including at least one processor, the method including is described. The code may include instructions executable by a processor to receive a set of data related to an environment and a set of individuals in the environment, determine a condition of the environment and the set of individuals in the environment based on a real-time analysis of the received set of data, where the condition includes a safety concern identified by a majority of the set of individuals, generate a real-time snapshot report based on the determining, where the real-time snapshot report includes the safety concern associated with the condition of the environment and the set of individuals in the environment, and provide the real-time snapshot report for display.

Some examples of the method, apparatuses, and non-transitory computer-readable medium described herein may further include operations, features, means, or instructions for identifying a category of the environment, and identifying a set of hazards associated with the category of the environment based on the set of data, where determining the safety concern may be further based on the identified set of hazards.

Some examples of the method, apparatuses, and non-transitory computer-readable medium described herein may further include operations, features, means, or instructions for identifying a work task allocation for each individual of the set of individuals, identifying a certification level associated with the work task allocation and a certification level of each individual of the set of individuals, and identifying a set of hazards associated with the work task allocation based on the set of data and the identified certification level associated with the work task and the certification level of each individual of the set of individuals, where determining the safety concern may be further based on the identified set of hazards.

Some examples of the method, apparatuses, and non-transitory computer-readable medium described herein may further include operations, features, means, or instructions for identifying an administrator associated with the environment, and transmitting, to the administrator or the set of individuals in the environment, or both, a message including the real-time snapshot report and instructions to prevent the safety concern, where the instructions include a micro-learning lesson for preventing the safety concern.

Some examples of the method, apparatuses, and non-transitory computer-readable medium described herein may further include operations, features, means, or instructions for including in the message a video or a transcript associated with the micro-learning lesson.

Some examples of the method, apparatuses, and non-transitory computer-readable medium described herein may further include operations, features, means, or instructions for including in the message a uniform resource locator link associated with the micro-learning lesson, where the uniform resource locator link directs the administrator to a third-party website for additional information associated with preventing the safety concern.

Some examples of the method, apparatuses, and non-transitory computer-readable medium described herein may further include operations, features, means, or instructions for receiving, from the administrator or the set of individuals in the environment, or both, a second message acknowledging the real-time snapshot report and the instructions to prevent the safety concern, where reception of the second message enables the administrator to authorize one or more work tasks for the set of individuals in the environment or enables the set of individuals to perform the one or more work tasks.

Some examples of the method, apparatuses, and non-transitory computer-readable medium described herein may further include operations, features, means, or instructions for distributing a set of messages to the set of individuals in the environment in accordance with a pairing scheme, where each message of the set of messages corresponds to an individual of the set of individuals, and the message further including a safety concern identified by the individual and an indication of the safety concern among the set of individuals.

Some examples of the method, apparatuses, and non-transitory computer-readable medium described herein may further include operations, features, means, or instructions for generating a list of instructions and preventative topics available for micro-learning and corresponding to a work task allocation for each individual of the set of individuals in the environment based on the received set of data and a set of historic data associated with the environment, and transmitting to a device associated with each individual of the set of individuals the list of instructions and preventative topics available for micro-learning.

Some examples of the method, apparatuses, and non-transitory computer-readable medium described herein may further include operations, features, means, or instructions for receiving, from each individual of the set of individuals, a message acknowledging the list of preventative topics available for micro-learning to prevent the safety concern, where reception of the message enables the set of individuals to perform a work task allocation.

Some examples of the method, apparatuses, and non-transitory computer-readable medium described herein may further include operations, features, means, or instructions for receiving, from a sensor wearable by an individual of the set of individuals, sensor data including environmental information associated with the environment or biometric information associated with the individual of the set of individuals, where receiving the set of data related to the environment and the set of individuals in the environment includes receiving the environmental information associated with the environment or the biometric information associated with the individual of the set of individuals.

In some examples of the method, apparatuses, and non-transitory computer-readable medium described herein, the sensor includes a camera, a wearable biometric sensor, or a temperature sensor, or a combination thereof.

In some examples of the method, apparatuses, and non-transitory computer-readable medium described herein, the biometric information associated with the individual in the environment includes: a blood pressure of the individual, a temperature of the individual, a heart rate and rhythm of the individual, a breathing pattern of the individual, or any combination thereof; and, and the environmental information associated with the environment includes a physical condition of the environment, a physical condition of the individual, a chemical condition of the environment, an ergonomic condition of the environment, or a radiation condition of the environment, or any combination thereof.

Some examples of the method, apparatuses, and non-transitory computer-readable medium described herein may further include operations, features, means, or instructions for receiving user-defined safety data including potential safety hazards related to the individual or the set of individuals or within the environment, where receiving the set of data related to the environment and the set of individuals in the environment includes receiving the user-defined safety data.

In some examples of the method, apparatuses, and non-transitory computer-readable medium described herein, the environment includes a worksite.

In some examples of the method, apparatuses, and non-transitory computer-readable medium described herein, the set of data related to the environment and the set of individuals in the environment may be user-defined.

### BRIEF DESCRIPTION OF THE DRAWINGS

FIG. 1 illustrates an example of a system for real-time analytics that supports analyzing and enabling safety procedures and rules in accordance with aspects of the present disclosure.

FIGS. 2 through 10 illustrate examples of a device including a graphical user interface that supports analyzing and enabling safety procedures and rules in accordance with aspects of the present disclosure.

FIGS. 11 and 12 show block diagrams of devices that support analyzing and enabling safety procedures and rules in accordance with aspects of the present disclosure.

FIG. 13 shows a block diagram of a analytics manager that supports analyzing and enabling safety procedures and rules in accordance with aspects of the present disclosure.

FIG. 14 shows a diagram of a system including a device that supports analyzing and enabling safety procedures and rules in accordance with aspects of the present disclosure.

FIGS. 15 through 18 show flowcharts illustrating methods that support analyzing and enabling safety procedures and rules in accordance with aspects of the present disclosure.

### DETAILED DESCRIPTION

A communication device, such as a smartphone, may have an interface allowing individuals to access features of the smartphone, as well as provide various types of communication content such as safety-related data (e.g., real-time snapshot reports, micro-learning lessons, among others), safety-related messaging (e.g., push notifications), and so on. The communication device may support communication with multiple other communication devices (e.g., other smartphones, servers, databases) of the safety-related data, safety-related messaging, and the like. In some examples, to achieve the benefits of the disclosure, the communication device may have a software application enabled to obtain or otherwise determine information regarding safety issues on a worksite in real time, providing analytical feedback regarding safety issues, providing educational information to employees, providing feedback to employees, and other safety and work improvements.

Therefore, the disclosure may provide improvements in real-time analytics for worksites, and more specifically analyzing and enabling safety procedures and rules for worksites. Furthermore, the disclosure described herein may provide benefits and enhancements to the operation of the communication device. For example, by supporting effective techniques for real-time analytics, operational characteristics, such as power consumption, processor utilization, and memory usage of the communication device may be reduced. The disclosure described herein may also provide efficiency to the communication device by reducing latency associated with processes related to the real-time analytics.

Aspects of the disclosure are initially described in the context of a system that relates to real-time analytics. Aspects of the disclosure are then illustrated by and described with reference to an interface (e.g., graphical user interface) of a device. Aspects of the disclosure are further illustrated by and described with reference to apparatus diagrams, system diagrams, and flowcharts that relate to methods and systems for analyzing and enabling safety procedures and rules.

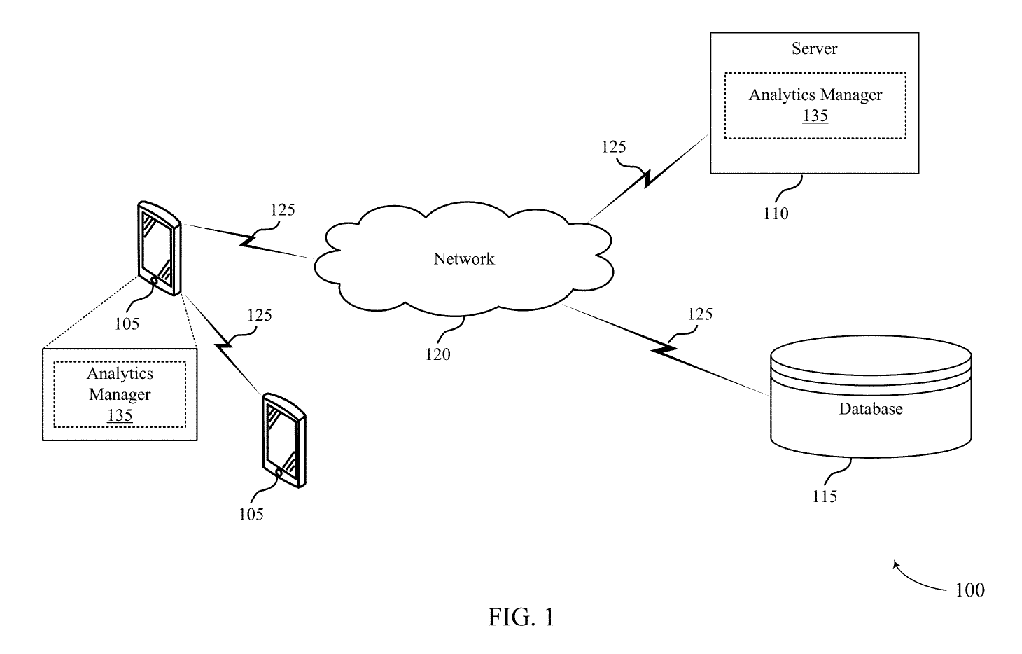

FIG. 1 illustrates an example of a system 100 that supports analyzing and enabling safety procedures and rules in accordance with aspects of the present disclosure. The system 100 may include devices 105, a server 110, and a database 115. Although, the system 100 illustrates two devices 105, a single server 110, a single database 115, and a single network 120, the disclosure applies to any system architecture having one or more devices 105, servers 110, databases 115, and networks 120. The devices 105, the server 110, and the database 115 may communicate with each other and exchange information that supports real-time analytics related to environments (e.g., a worksite, such as, but not limited to, at a mining operating, drilling rig, construction site, and the like) and/or individuals associated with the devices 105 that may be within (e.g., located geographical within, assigned to, or associated with) the environments, via network 120 using communications links 125.

The devices 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to analyzing and enabling safety procedures and rules for example, transmitting, receiving, and storing data, such as safety-related data (e.g., real-time snapshot reports, micro-learning lessons, among others). The devices 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may also be able to communicate directly with another device (e.g., using a peer-to-peer (P2P) or device-to-device (D2D) protocol). For example, the devices 105 may be able to receive from or transmit to another device 105 variety of information, such as instructions or commands (e.g., safety-related data, flashcards, acknowledgments).

The devices 105 may include an analytics manager 135. While, the system 100 illustrates only one device 105 including the analytics manager 135, it may be an optional feature for the devices 105. In some examples, the server 110 may additionally, or alternatively include an analytics manager 135. In some cases, a portion or all of techniques described herein supporting analyzing and enabling safety procedures and rules may be performed on the devices 105 or the server 110, or both. In some examples, the devices 105 may have an application that may receive information (e.g., download) from the server 110, database 115 or another device 105, or transmit (e.g., upload) data, among other safety-related data to the server 110, the database 115, or to another device 105 via using communications links 125.

By way of example, an individual may download the application (e.g., including analytics manager 135) onto a device 105 from an application distribution platform hosted by the server 110. A device 105 may receive a digital distribution from the application distribution platform. A typical application distribution platform may allow individuals to discover, browse, share, and download applications from the platform. As such, a digital distribution may be a form of delivering media content such as software applications, without the use of physical media but over online delivery mediums, such as the Internet. In some examples, an individual may download a same application across multiple devices 105.

The analytics manager 135 may be a software application accessible to an individual via an interface of a device 105. The interface may be a resistance touch-based interface, a capacitance touch-based interface, a surface acoustic wave-based interface, an optical touch-based interface, an electromagnetic guidance-based interface, among others. The software application may include multiple features (e.g., processes, operations, classes, functions, configuration files, executable files).

In some examples, individuals affiliated with a company and/or a worksite utilizing the software application (also referred to herein as simply “the application”) may have the application downloaded onto his or her device 105, and a specific instance of the application associated with a specific employee. An administrator, such as an information technologist, may associate information related to the employee, the company, the worksite, and other information with the specific instance of the application, such that when the individual accesses and interacts with the application, the application may be customized to each individual. When an individual is first given access to the application, the individual may further customize the application by providing information such as an avatar, name, skill set, experience, desired work and locations, acceptable pay scales, certifications, and other key information about the individual as described herein. The individual may also be prompted to identify others (individuals) with similar credentials and provide referral information that would be used by the company to expand its employment pool.

The analytics manager 135 may in some examples provide real-time analytics to support safety and worksite improvements based at least in part on data collected via sensors or provided by an individual via devices 105. For example, analytics manager 135 may receive a set of data related to an environment (e.g., a worksite) and a set of individuals in the environment, and determine a condition of the environment and the set of individuals in the environment based at least in part on a real-time analysis of the received set of data. The condition may include a safety concern identified by a majority of the set of individuals. A majority may be a number of individuals of the set that may be equal to or greater than a threshold number of individuals of the set. In some examples, the data may be user-defined safety data (e.g., information provided by individuals via device 105) including potential safety hazards related to the individual or the set of individuals or within the environment.

In some examples, the analytics manager 135 may identify a category of the environment. For example, analytics manager 135 may identify a category of the environment to be a mining operating, drilling rig, construction site, and the like. According to the category of the environment, the analytics manager 135 may identify a set of hazards associated with the environment. In some examples, the analytics manager 135 may identify a set of hazards associated with the environment using a public or private database storing historical hazards and/or based at least in part on the set of received data (e.g., from the individuals via devices 105). In this example, the analytics manager 135 may correlate historical hazards with the set of received data to identify a set of hazards associated with the environment.

In some examples, the analytics manager 135 may identify a work task allocation for each individual of the set of individuals, identify a certification level associated with the work task allocation and a certification level of each individual of the set of individuals to identify a set of hazards associated with the work task allocation based at least in part on the set of data and the identified certification level associated with the work task and the certification level of each individual of the set of individuals. In this example, the safety concern may be based at least in part on the identified set of hazards (e.g., physical hazards (e.g., working at heights, poor housekeeping), electrical hazards (e.g., exposed electrical elements), mechanical hazards (e.g., exposed mechanical elements), among others).

The analytics manager 135 may generate and provide a real-time snapshot report based at least in part on the determining. The real-time snapshot report may include the safety concern associated with the condition of the environment and the set of individuals in the environment. In some examples, the analytics manager 135 may identify an administrator associated with the environment. For example, the analytics manager 135 may identify a foreman for a certain worksite. The analytics manager 135 may transmit, to the administrator or the set of individuals in the environment, or both, a message including the real-time snapshot report and instructions to prevent the safety concern. In some examples, the instructions may include a micro-learning lesson for preventing the safety concern, as described herein. In some examples, the analytics manager 135 may include in the message a video or a transcript associated with the micro-learning lesson. For example, the analytics manager 135 may include in the message a uniform resource locator link associated with the micro-learning lesson, wherein the uniform resource locator link directs the administrator to a third-party website for additional information associated with preventing the safety concern. The message may be an electronic message including an email, text, push notification, among others.

In some examples, analytics manager 135 may generate a list of instructions and preventative topics available for micro-learning and corresponding to a work task allocation for each individual of the set of individuals in the environment based at least in part on the received set of data and a set of historic data associated with the environment, and transmit to a device 105 associated with each individual of the set of individuals the list of instructions and preventative topics available for micro-learning. The analytics manager 135 may receive, from the administrator or the set of individuals in the environment, or both, a second message acknowledging the real-time snapshot report and the instructions to prevent the safety concern. The reception of the second message may enable the administrator to authorize one or more work tasks for the set of individuals in the environment or the enable the set of individuals to perform the one or more work tasks. In some examples, as described herein, analytics manager 135 may distribute a set of messages to the set of individuals in the environment in accordance with a pairing scheme, where each message of the set of messages corresponds to an individual of the set of individuals, and the message may include a safety concern identified by the individual and an indication of the safety concern amongst the set of individuals.

The analytics manager 135 may be part of a general-purpose processor, a digital signal processor (DSP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof) or other programmable logic device, discrete gate or transistor logic, discrete hardware components, or any combination thereof designed to perform the functions described in the disclosure, and/or the like. For example, the analytics manager 135 may process data (e.g., safety-related data, user-defined data, environmental data, biometric data) from and/or write data (e.g., safety-related data, user-defined data, environmental data, biometric data, training data, safety data, employee data, worksite data, company data, legal information, third party resources, user preferences, and the like) to a local memory of the device 105 or to the database 115. In some embodiments, the devices 105 may support algorithms may include one or more algorithms configured to improve detection of safety issues, analyze safety issues to provide feedback on improvements, provide safety education, provide employee encouragement, and the like.

The server 110 may be a data server, a cloud server, a proxy server, a web server, an application server, a communications server, a home server, a mobile server, or any combination thereof. The server 110 may optionally store data (e.g., safety-related data, user-defined data, environmental data, biometric data). The data (e.g., safety-related data, user-defined data, environmental data, biometric data) may allow the devices 105 to analyze and enable safety procedures and rules to prevent worksite hazards or accidents. The server 110 may also transmit to the devices 105 a variety of information, such as instructions or commands, for example such as analytical feedback regarding safety issues, educational information to employees, feedback to employees, and other safety and work improvements.

The database 115 may store a variety of information, such as instructions or commands (e.g., safety-related data, user-defined data, environmental data, biometric data, schedule data related to individuals, work allocation data, certification level data, among other data). The devices 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, among others that stores the variety of information, such as instructions or commands (e.g., safety-related data, user-defined data, environmental data, biometric data, schedule data related to individuals, work allocation data, certification level data, among other data).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G) for example), etc. Network 120 may include the Internet.

The communications links 125 shown in the system 100 may include uplink transmissions from the device 105 to the server 110 and the database 115, and/or downlink transmissions, from the server 110 and the database 115 to the device 105. The wireless links 125 may transmit bidirectional communications and/or unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

Accordingly, the system 100 may provide improvements in real-time analytics for worksites, and more specifically analyzing and enabling safety procedures and rules for worksites. Furthermore, the system 100 may provide benefits and enhancements to the operation of the devices 105 and/or server 110. For example, by supporting effective techniques for real-time analytics, operational characteristics, such as power consumption, processor utilization, and memory usage of the devices 105 and/or server 110 may be reduced. The system 100 may also provide efficiency to the devices 105 and/or server 110 by reducing latency associated with processes related to the real-time analytics.

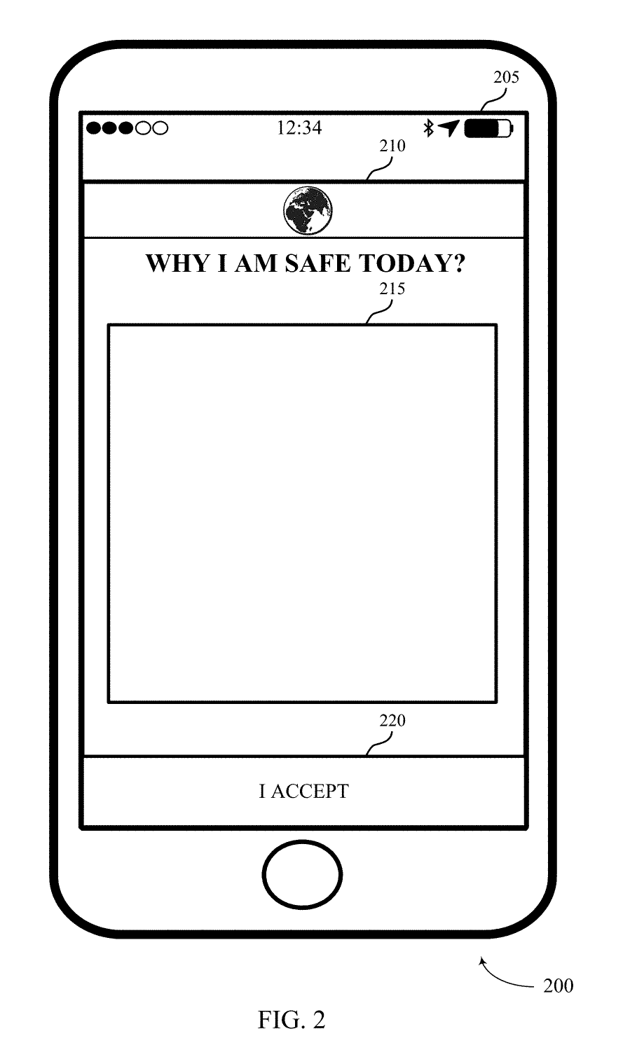

FIG. 2 illustrates an example of a device 200 including a graphical user interface 205 that supports analyzing and enabling safety procedures and rules in accordance with aspects of the present disclosure. In some examples, the device 200 may implement aspects of the system 100. For example, the device 205 may be the corresponding devices 105 described with reference to FIG. 1. The graphical user interface 205 may include an interface 210 of an application running on the device 200, in accordance with at least some example embodiments. The interface 210 may be an intro-interface that an individual (e.g., an employee) may encounter after the application is downloaded onto the device 200. The interface 210 may provide the individual a window 215 to input an intention for the day. For example, the application may prompt an individual (e.g., an employee) to enter an answer to a question (e.g., “WHY I AM SAFE TODAY?”).

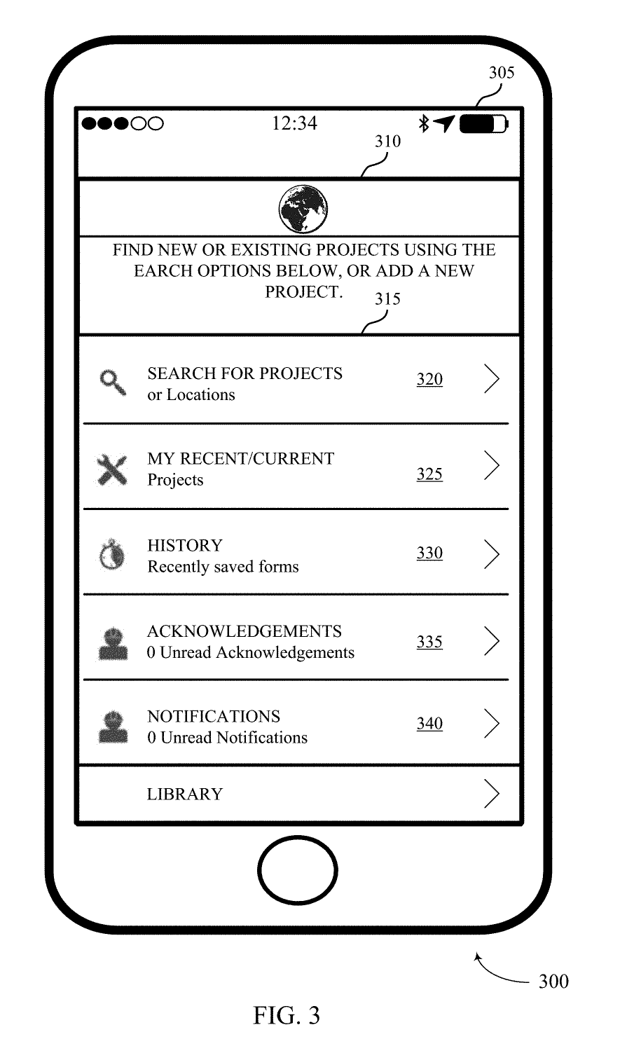

The interface 210 of the application may enable the individual to provide an intention, goal, commentary, etc., which may drive his or her intentions for the day. For example, an individual may enter “I am safe today because of my family,” or “I am safe today because today is my 5th anniversary, and I have dinner plans with my husband.” The reason may not necessarily be personal and may be work related, such as “I am safe today because I want to contribute to a safe work environment.” The intention submitted may be transmitted in real-time to another individual (e.g., another employee in a company based on a pairing scheme or selected by the individual) for an acknowledgement, which will be described in more detail further below. For example, an individual may submit his or her answer by selecting the “I Accept” option 220 on the interface 210. Once the intention has been submitted, the individual may be directed to an example menu page, as shown in FIG. 3.

FIG. 3 illustrates an example of a device 300 including a graphical user interface 305 that supports analyzing and enabling safety procedures and rules in accordance with aspects of the present disclosure. In some examples, the device 300 may implement aspects of the system 100. For example, the device 300 may be the corresponding devices 105 described with reference to FIG. 1. By way of example, the graphical user interface 305 may display an interface 310 (e.g., a menu page) in an application as described in FIGS. 1 and 2. The interface 310 may include a portion 315 with a set of selectable menu options for an individual. The set of selectable menu options may include, but are not limited to, an option 320 to search for (or view) specific projects and/or locations (e.g., worksites), a second option 325 to search for (or view) specific current and/or most recent project on which the individual was assigned and/or worked, a third option 330 to search for (or view) specific historical content of recently saved forms (e.g., hours worked, projects, locations of previous worksites, training material, etc.) including safety documents, a fourth option 335 to search for (or view) specific acknowledgements the individual may have to respond to, and a fifth option 340 to search for (or view) specific notifications. The portion 315 may in some examples, include more or fewer selectable menu options. Accordingly, the application may provide an efficient and effective mechanism for project selection by individuals using location mapping, geofencing, or storage of data from prior user inputs.

Returning to FIG. 1, the analytics manager 135 may enable real-time hazard analysis at, for example, a worksite, such as, but not limited to, at a mining operating, drilling rig, construction site, and the like. In some examples, employees dispatched to work at a worksite may be under obligations to follow and comply with safety standards. Some safety standards may be established by a governing entity (e.g., a company hired to manage the work), some safety standards may be established by a foremen or other administrative personnel associated with the worksite as a whole, or with a particular work group, and/or some safety standards may be established by governmental regulatory agencies and administrations, such as the Occupational Safety and Health Administration (OSHA).

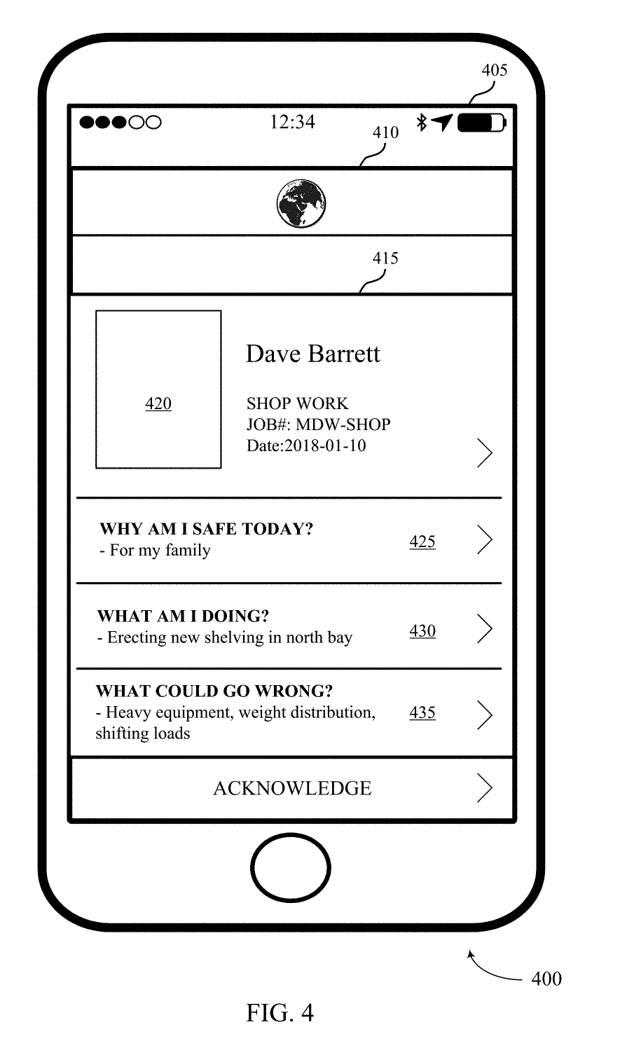

In some examples, safety concerns may be addressed after the fact, due to the way reporting issues and concerns are handled. In other words, many times, a safety issue is not known until after an issue has occurred, and thus, the remedies are reactionary as opposed to preventative. In order to address safety concerns and issues before an event arises, the analytics manager 135 may query individuals at a worksite to enter into an application (e.g., a safety-related application) safety concerns, potential hazards, and other issues the individual recognizes at a time the concerns are entered into the application. For example, an employee may begin his shift at a drilling rig. Before he can begin work, he will be directed to open the application on his smartphone (e.g., device 105). The smartphone may prompt him to enter an answer to the question “WHY AM I SAFE TODAY?” as described with reference to FIG. 2. The application may then direct the employee/user to fill in information into a “flashcard.” An example flashcard is shown and further described with reference to FIG. 4.

FIG. 4 illustrates an example of a device 400 including a graphical user interface 405 that supports analyzing and enabling safety procedures and rules in accordance with aspects of the present disclosure. In some examples, the device may implement aspects of the system 100. For example, the device 400 may be the corresponding devices 105 described with reference to FIG. 1. By way of example, the graphical user interface 405 may display an interface 410 of an application having a portion showing an example flashcard 415 for an employee “Dave Barrett.” Dave Barrett may be given an opportunity, at a previous time, to personalize his profile with the application, including providing a personal identifier 420 (e.g., photograph, avatar, or other personalization options). At the beginning of each day, or shift, or change in work environment, Dave may be asked to enter information in one or more fields (e.g., fields 425 through 435). For example, Dave may enter in one or more fields which team or crew Dave may be working (e.g., SHOP WORK), a Job # (e.g., MDW SHOP), and a date (e.g., 2018-10-10). Dave can additionally, or alternatively (or previously has) enter an answer to a question within a first field 425 (e.g., “WHY AM I SAFE TODAY?” “For my family”), an answer to a second question within a second field 430 (e.g., WHAT AM I DOING?” “Erecting new shelving in north bay”), and enter an answer to a third question within a third field 435 (e.g., “WHAT COULD GO WRONG?” “Heavy equipment, weight distribution, shifting loads”). In some examples, the application may associate one or more of the above example entries may to a corresponding employee, job, job site, and safety concerns and issues. For example, the entry for “WHAT AM I DOING?” may provide data to associate with each employee, each job, each job site, and safety concerns and issues provided in the “WHAT COULD GO WRONG?” entry. Having data associated with at least each of these data points may enable a real-time analysis of safety issues and concerns associated with each employee, job site, job, etc., for which a foreman or other administrator may be made aware at the moment and address, correct, and/or prevent any events or issues before they occur.

Returning to FIG. 1, in some examples, an individual may enter safety issues he or she believes to be of immediate or near-immediate concern using his or her own words. In other examples, the individual may be directed to select from a group of categories or pre-determined selections of potential hazards determined to be relevant for particular worksites and/or jobs. For example, because Dave is working in construction, he may be directed to pick from ten example categories. The ten example categories may be chosen by keywords data mined from previous entries, or other documentation related to the worksite, type of work, company provided key words, regulatory keywords, etc. Keywords may be pulled from documents through data input, optical character recognition (OCR) software, and other applications to read and obtain keyword data. Although not specifically shown, the keywords may be provided on a drop down menu from which the individual may select, may be shown as a list with checkboxes, or by any other visualization that enables the individual to make a selection of the current hazards.

In some examples, devices 105, such as cell phones and tablets, may be prohibited from a worksite for privacy concerns. In these example cases, an employee may be directed to fill out a flashcard manually (e.g., using pen and paper). Before beginning work, the employee may be directed to scan the flashcard into a digital format which can be uploaded to the application. In some examples, the application running on devices 105 may have a scanning element or a photograph input option where the card may be scanned directly into the devices 105. For example, employees may capture an image of the physical flashcard, and the devices 105 may perform an image recognition algorithm to parse information on the flashcard. As with entering data directly into the application, the scanned physical flashcard may be immediately analyzed in real-time to provide real-time results. In some examples, real-time may be a set number of minutes, seconds or less (e.g., 10 seconds, minutes or less). As each flashcard may be submitted and uploaded, the flashcard may be transmitted to another randomly selected employee to provide an acknowledgment, and data related to the safety issues (e.g., WHAT COULD GO WRONG?) may be analyzed in real-time to provide a real-time (and constantly updated) report of safety concerns. Both the acknowledgement and the real-time hazard reporting are discussed in more detail herein.

In addition to user-entered safety data, the application may also obtain safety data from sensors. For example, devices 105 or the server 110 may receive, from a sensor wearable by an individual of the set of individuals, sensor data including environmental information associated with the environment or biometric information associated with the individual of the set of individuals. In some examples, the sensors may be sensors located at a worksite, such as cameras (including video cameras), microphones, vibration sensors, motion sensors, infrared sensors, radio frequency sensors, temperature sensors, pressure sensors, and the like. In addition, sensors may include biometric sensors. Biometric sensors may be located at the worksite and/or physically attached to or associated with each employee. For example, biometric sensors may include, but are not limited to, health monitors to determine blood pressure, temperature, heart rate, breathing patterns, muscle strain, and the like. Such sensors may aid in determining a safety situation is occurring by recognizing an unexpected increase in blood pressure, body temperature, an increase in heart rate or rapid breathing, and the like. In addition, the user may wear a camera (which may be attached to the user's body, or may be embedded in the lens of glasses), which may be used to obtain additional visual information to aid in correlating data.

For example, an individual may indicate that there is a weather issue at an off-shore drilling rig which may provide precarious conditions (e.g., high winds, severe rain, lightning strikes, high wave situations, etc.). In addition to relying on an individual's personal language to provide context for the safety concerns, the individual may be wearing glasses containing sensors to provide additional information. For example, an individual may input that there is a high wind situation via the application, but the camera may provide detailed data on wave patterns or show there is lightning in the vicinity. Regardless of the type of sensor, the data may be sent in real-time for analysis. In addition, push notifications may be enabled to provide the employee, a foreman, an administrator, and/or a third party information about the safety issues or other information. In some examples, once at least one individual enters safety concerns into the flashcard portion of the application via device 105 (or a physical flashcard is scanned into the application), the safety data may be analyzed in real-time to provide a snapshot of issues and concerns that should be addressed.

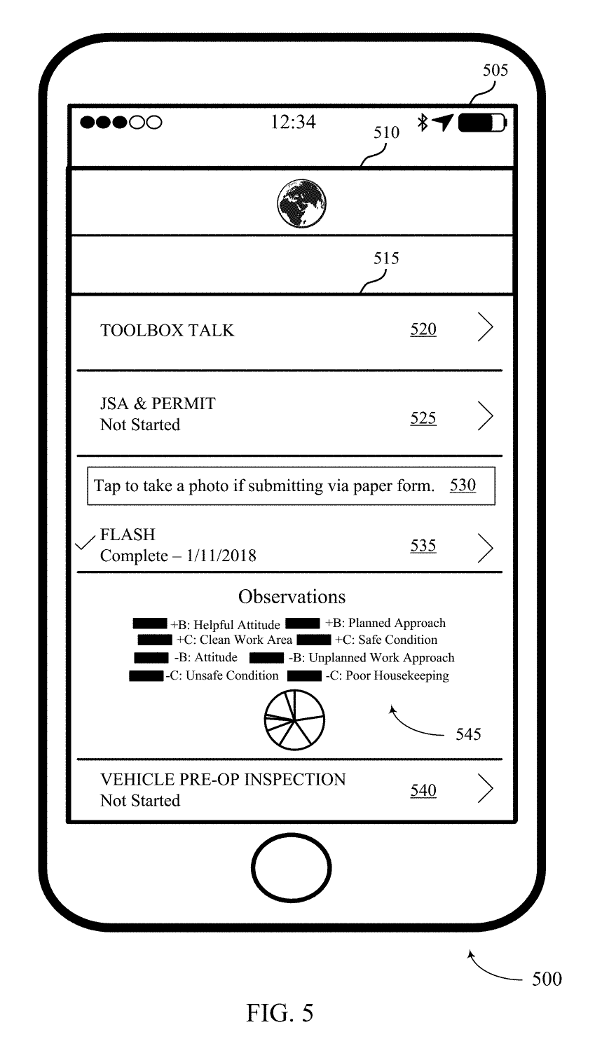

FIG. 5 illustrates an example of a device 500 including a graphical user interface 505 that supports analyzing and enabling safety procedures and rules in accordance with aspects of the present disclosure. In some examples, the device 500 may implement aspects of the system 100. For example, the device 500 may be the corresponding devices 105 described with reference to FIG. 1. By way of example, the graphical user interface 505 may display an interface 510 in an application as described in FIGS. 1 through 4. In some examples, interface 510 may display a completed flashcard 515. The flashcard 515 may include a set of selectable menu options for an individual. The set of selectable menu options may include, but are not limited to, a first option 520 to view or enter a forum (e.g., toolbox talk), a second option 525 to view or enter certification level, permits, educational information, a third option 530 to capture a photo of a physical flashcard (e.g., a user may tap option 530 to take a photo if submitting via a paper form), a fourth option 535 to view or enter flashcard information, and a fifth option 540 to view or enter vehicle pre-op inspection. The flashcard 515 may, in some examples, includes more or fewer selectable menu options. In some examples, once an individual completes his or her flashcard 515, the individual may receive an indication that the flashcard 515 has been completed (e.g., a check mark as shown next to FLASH-Complete-1/11/2018). Completing a flashcard may be a necessary element of an employee's day, and in some cases, an employee may not be able to begin work without an indication that his or her flashcard has been completed.

After the completion of the flashcard 515, the flashcard 515 (or interface 515) may show a visual representation 545 of a set of real-time safety concerns. In the example of FIG. 5, eight potential safety issues have been identified through analyzing flashcards. Although safety issues may be hazards (e.g., negative), safety issues may not be limited to negative issues or hazards, and may be positively noted conditions as well. For example, the following safety issues may be of note: helpful attitude; planned approach; clean work area; safe condition; attitude; unplanned work approach; unsafe condition; and poor housekeeping. Each of these safety conditions may have been generated and/or selected using keywords. In some embodiments, the safety issues may be quickly identified through the use of graphs and other display method. In other embodiments, the safety issues may be pushed as a notification to a device of an administrator, foreman, third party, employee, etc.

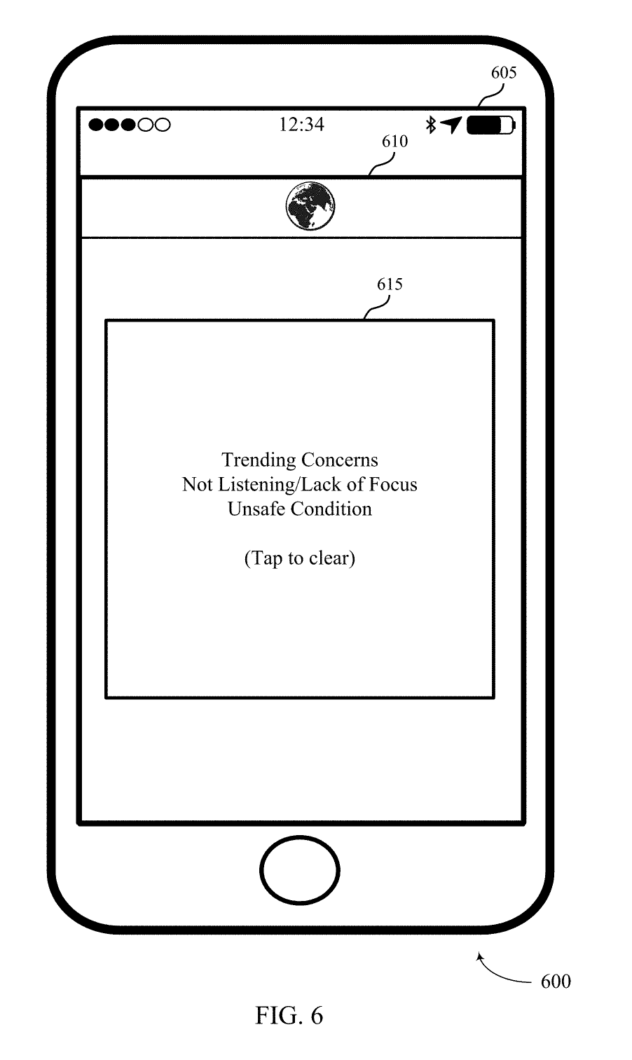

FIG. 6 illustrates an example of a device 600 including a graphical user interface 605 that supports analyzing and enabling safety procedures and rules in accordance with aspects of the present disclosure. In some examples, the device 600 may implement aspects of the system 100. For example, the device 600 may be the corresponding devices 105 described with reference to FIG. 1. By way of example, an interface 610 of an application (e.g., running analytics manager) may display an example popup notification 615 indicting real-time trending concerns and safety issues for an individual associated with the device 600. In some examples, the real-time trending concerns and safety issues may be displayed at a time the individual accesses the application. For example, in the example of FIG. 6, the individual has accessed the application from the device 600, and the popup notification 615 may be displayed on the interface 605 of the device 600. In this example, entries made into flashcards are analyzed in real-time, and it is determined that the trending concerns for the individual are “Not Listening/Lack of Focus,” and “Unsafe conditions.” Because the trending concerns are determined from real-time data entry during the flashcard stage, and analyzed as safety concerns are inputted, the trending concerns may change over time. In addition, the trending concerns may be different for each individual, for each worksite, for different times of the day, etc.

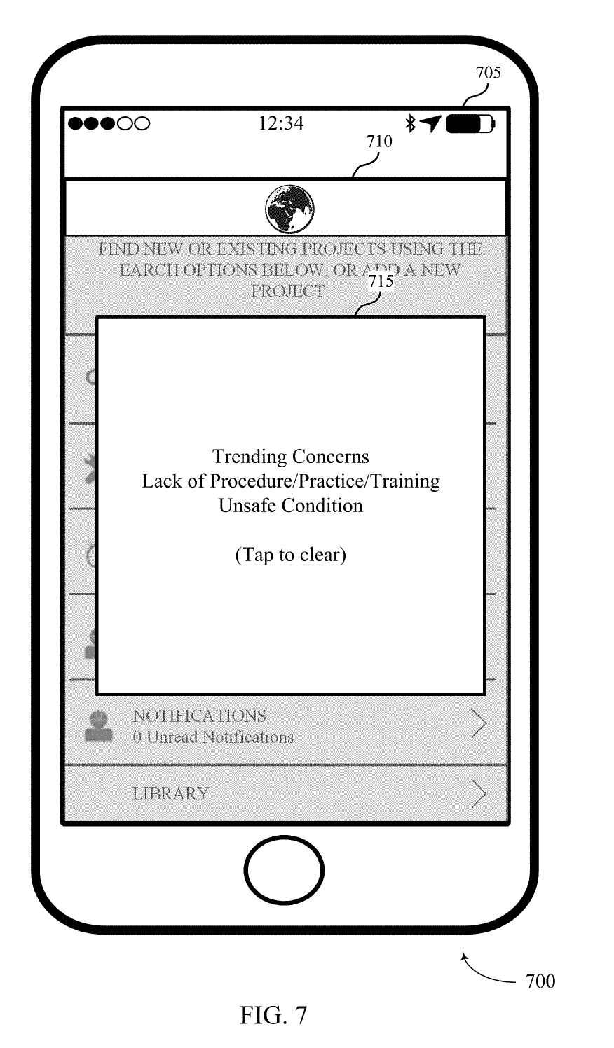

FIG. 7 illustrates an example of a device 700 including a graphical user interface 705 that supports analyzing and enabling safety procedures and rules in accordance with aspects of the present disclosure. In some examples, the device 700 may implement aspects of the system 100. For example, the device 700 may be the corresponding devices 105 described with reference to FIG. 1. By way of example, an interface 710 of an application (e.g., running analytics manager) may display an example popup notification 715 indicting real-time trending concerns and safety issues for another individual associated with the device 700. For example, in contrast to the individual in FIG. 6, the real-time trending concerns for the this individual is a “lack of procedure/practice/training” and “unsafe conditions.” Once the individual makes note of the trending concerns, he or she may tap the popup notification 715 to dismiss the notification.

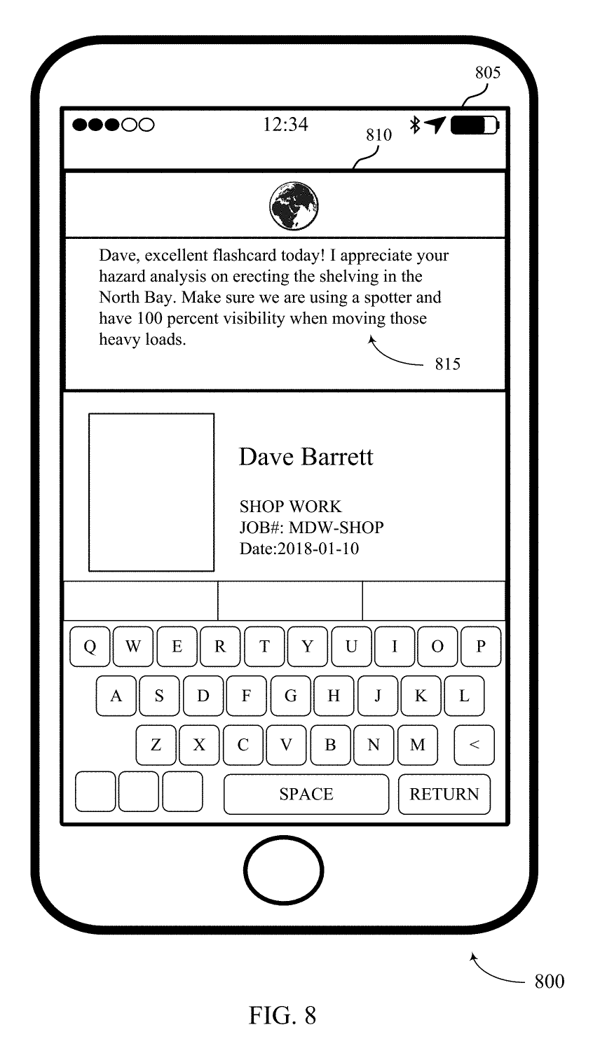

FIG. 8 illustrates an example of a device 800 including a graphical user interface 805 that supports analyzing and enabling safety procedures and rules in accordance with aspects of the present disclosure. In some examples, the device 800 may implement aspects of the system 100. For example, the device 800 may be the corresponding devices 105 described with reference to FIG. 1. By way of example, FIG. 8 may show an example of an acknowledgement element 815 provided via an interface 810 on an application. As previously described with respect to FIG. 4, example employee Dave Barrett has filled in his flashcard for the day before starting the day. When Dave submits his flashcard, the flashcard may be sent to a second employee, randomly selected, to read Dave's flashcard and make comments. It should be noted that every employee associated with a company may be required to fill out a flashcard before beginning work, and every employee may be required to acknowledge another employee's flashcard. In some examples, the acknowledgement of another employee's flashcard serves the purpose of providing positive feedback and encouraging teamwork.

With regard to matching flashcards between employees, several embodiments are considered. On one embodiments, algorithms are used to randomly pair employees. The random pairing may be the default method, such that every employee from CEO to site worker may have an equal chance of being paired with another employee. In another embodiment, different employees (either individually or by group or experience, for example), may be given different weight values such that some employees are selected as a mentoring group and some employees are selected as mentees. Using the mentor/mentee algorithm, pairings may be random between the groups, although the groups may be pre-determined or selected by weight. In yet another embodiment, individuals may be given specific weights such that the algorithm pairs employees based on weighted decisions; for example, employees that have been with the company longer may have a higher weight, and may be pairs with employees that have been with the company less time and thus have a lower weight. Other pairings are considered, such as pairings determined by company, by worksite, by location, by job, by seniority, by user determination, etc.

Once a pairing has been determined by the system, an employee receives a notification that a flashcard is available for his or her review. The receiving employee may open the flashcard, review the information, and provide “acknowledgment” of the flashcard. For example, a second employee has received Dave Barrett's flashcard via application and has provided the following acknowledgement 815: “Dave, excellent flashcard today! I appreciate your hazard analysis on erecting the shelving in the North Bay. Make sure we are using a spotter and have 100% visibility when moving those heavy loads.”

Both the providing and receiving parties benefit from the acknowledgment, as the acknowledgement is meant to increase teamwork and employee visibility and provide positive and constructive feedback. In some embodiments, each employee's flashcard may be selectable and/or displayed on a “dashboard,” so that each employee's flashcard may be visible to all, or selected, employees for review. Further, the acknowledgment feature expands beyond the jobsite into the corporate office where employees perform peer-to-peer acknowledgments to lift morale, build the company's culture and provide individual encouragement and recognition. For example, an employee processing expense reports in the accounting department may see the flashcard of an employee in the business development department and say “I've noticed on your flashcard and by your expense report that you have been out of town a lot this month. I know that must be difficult with your young family (viewing the avatar of a family photo). Please know your efforts are truly appreciated by me and all in the accounting department. With your efforts we could not maintain our business.” In addition to filling out a flashcard, and addressing the employee's assigned “acknowledgment,” employees may also be required to participate in micro-learning before the day's work may begin. The application provides a personalized micro-learning interface.

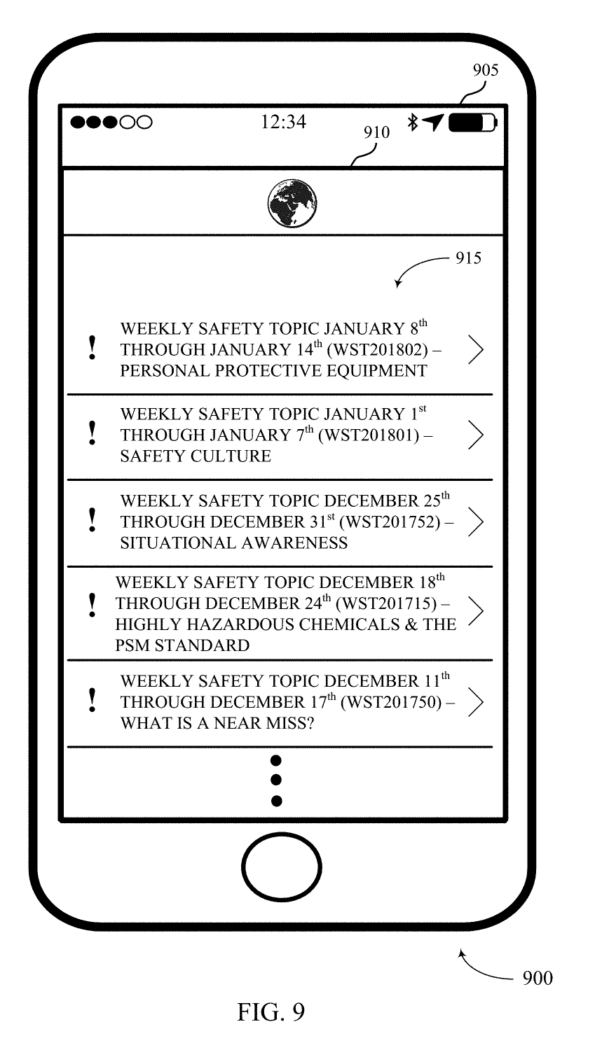

FIG. 9 illustrates an example of a device 900 including a graphical user interface 905 that supports analyzing and enabling safety procedures and rules in accordance with aspects of the present disclosure. In some examples, the device 900 may implement aspects of the system 100. For example, the device 900 may be the corresponding devices 105 described with reference to FIG. 1. By way of example, FIG. 9 may show a screen-shot of possible weekly safety topics 915 in an interface 910 of an application running on the device 900. Weekly safety topics 915 may be available for micro-leaning and may be determined based on each employee's inputted safety issues in their flashcard. The weekly safety topics 915 may also be determined by other user-input such as by a foreman or administrator, who has determined that the crew at a certain worksite or location may need to learn about a specific topic. In other embodiments, weekly safety topics 915 available for micro-learning may be driven on current laws and regulations. In still other embodiments, micro-learning lessons may be part of a series of lessons based on a specific job, location, worksite, company, etc. Micro-learning may be accomplished by providing employees with videos and text to learn about a topic. For example, FIG. 9 may show a plurality of possible topics, any of which is selectable to provide the employee with a short (e.g., five minute video), text, and/or links to third-party sites to provide additional information. In addition, employees may be provided with other links to increase their knowledge on a specific topic if they are unclear on what they have viewed or read. Micro-learning lessons may be stored in a database and accessible on- or off-line.

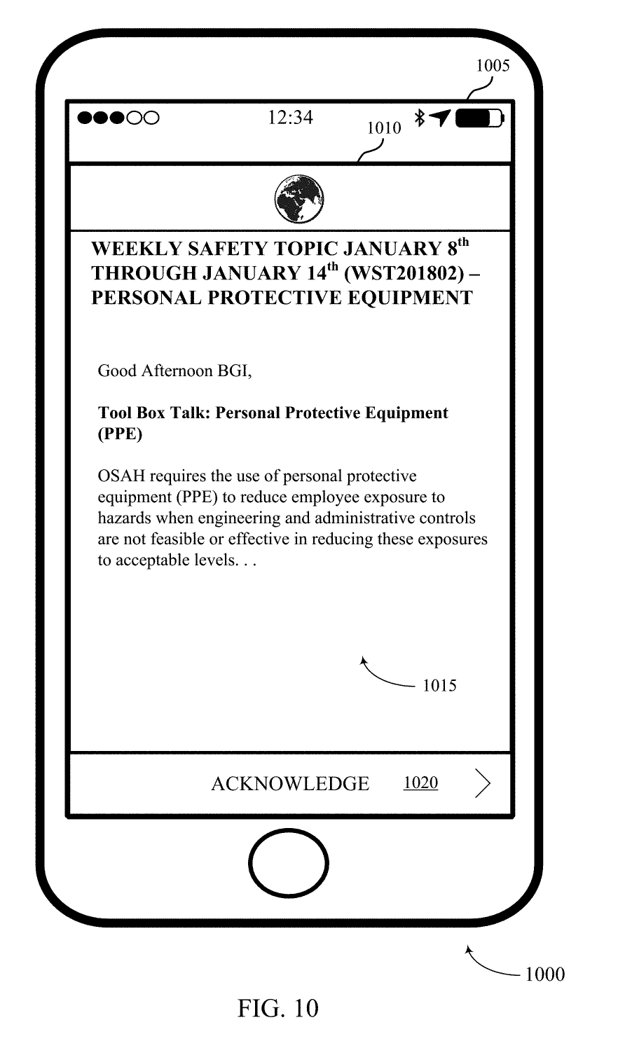

FIG. 10 illustrates an example of a device 1000 including a graphical user interface 1005 that supports analyzing and enabling safety procedures and rules in accordance with aspects of the present disclosure. In some examples, the device 1000 may implement aspects of the system 100. For example, the device 1000 may be the corresponding devices 105 described with reference to FIG. 1. By way of example, graphical user interface 1005 may display an interface 1010 of an application, which may provide an example micro-learning lesson 1015 (e.g., “Personal Protective Equipment”). After an employee has completed the micro-learning lesson 1015, he or she may acknowledge 1020 his or her participating. Following the lesson, the employee may be asked to participate in a quiz. Based on the correctness of the employee's answers, the employee may be directed back to the micro-learning lesson 1015 to refresh his or her learning, before being asked to take the quiz again. If the individual completes the quiz with correct answers, he or she may have his or her flashcard marked as complete.

Returning to FIG. 1, in some examples, based on each element of the flashcard (e.g., safety topics, acknowledgments, micro-learning, etc.), employees may be given scores and/or ratings. For example, an employee that consistently finishes his or her flashcard before a given time (e.g., 9:00 a.m.) may be given a 5-star rating for timeliness, whereas an employee who finishes his or her flashcard before noon may be given a 3-star rating, and an employee that fails to finish his flashcard may be given a 1-star rating. Similarly, continued and significant-effort put into acknowledging another employee's flashcard may result in a higher rating than a superficial or copy-and-paste type response. Based on an aggregate of ratings, each employee may be given rewards, promoted, or additionally acknowledgment for their contribution to the company and/or worksite and/or job.

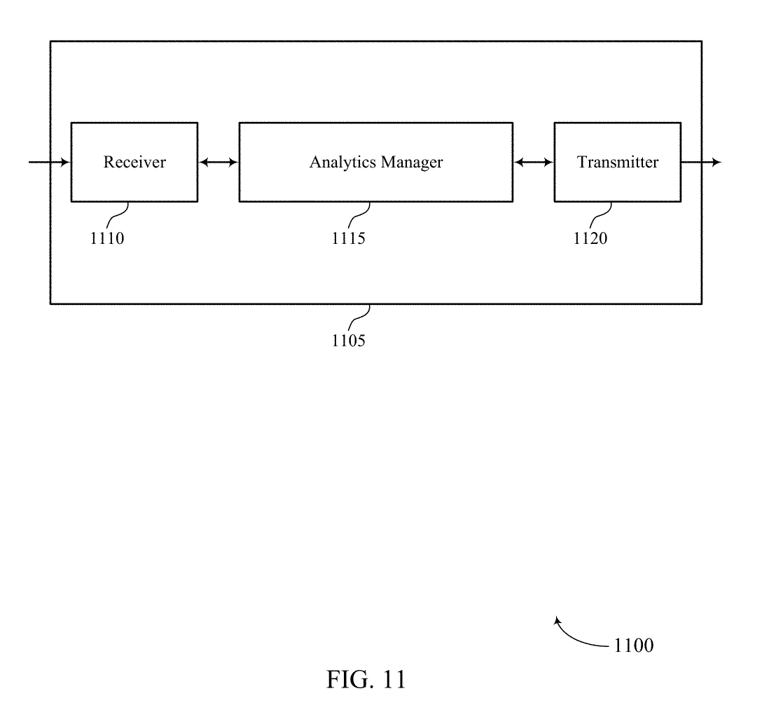

FIG. 11 shows a block diagram 1100 of a device 1105 that supports analyzing and enabling safety procedures and rules in accordance with aspects of the present disclosure. The device 1105 may be an example of aspects of a device as described herein. The device 1105 may include a receiver 1110, an analytics manager 1115, and a transmitter 1120. The device 1105 may also include a processor. Each of these components may be in communication with one another (e.g., via one or more buses).

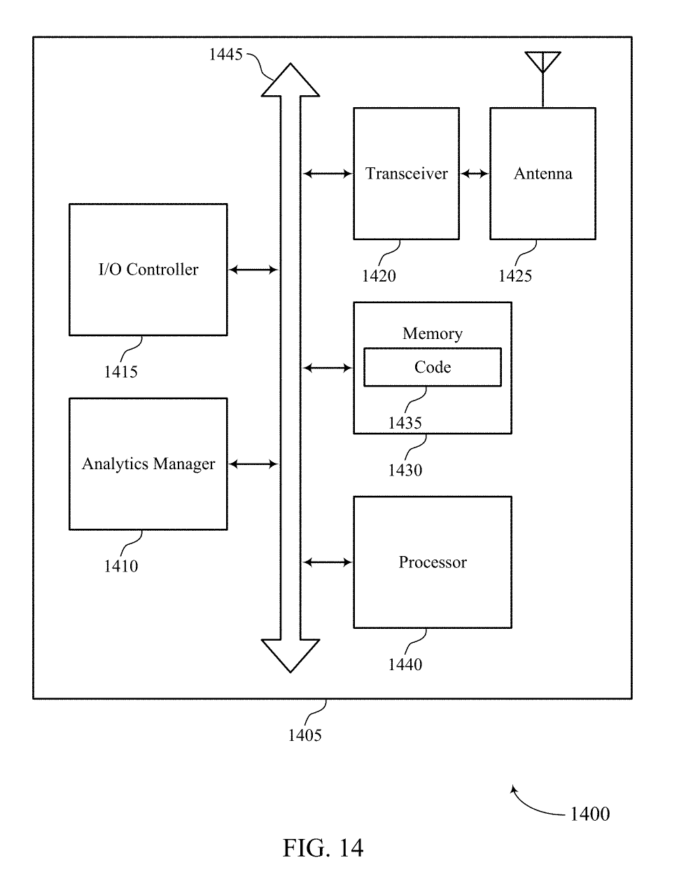

The receiver 1110 may receive information such as packets, user data, or control information associated with various information channels (e.g., control channels, data channels, and information related to analyzing and enabling safety procedures and rules, etc.). Information may be passed on to other components of the device 1105. The receiver 1110 may be an example of aspects of the transceiver 1420 described with reference to FIG. 14. The receiver 1110 may utilize a single antenna or a set of antennas.

The analytics manager 1115 may receive a set of data related to an environment and a set of individuals in the environment, determine a condition of the environment and the set of individuals in the environment based on a real-time analysis of the received set of data, where the condition includes a safety concern identified by a majority of the set of individuals, generate a real-time snapshot report based on the determining, where the real-time snapshot report includes the safety concern associated with the condition of the environment and the set of individuals in the environment, and provide the real-time snapshot report for display. The analytics manager 1115 may be an example of aspects of the analytics manager 1410 described herein.

The analytics manager 1115, or its sub-components, may be implemented in hardware, code (e.g., software or firmware) executed by a processor, or any combination thereof. If implemented in code executed by a processor, the functions of the analytics manager 1115, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The analytics manager 1115, or its sub-components, may be physically located at various positions, including being distributed such that portions of functions are implemented at different physical locations by one or more physical components. In some examples, the analytics manager 1115, or its sub-components, may be a separate and distinct component in accordance with various aspects of the present disclosure. In some examples, the analytics manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

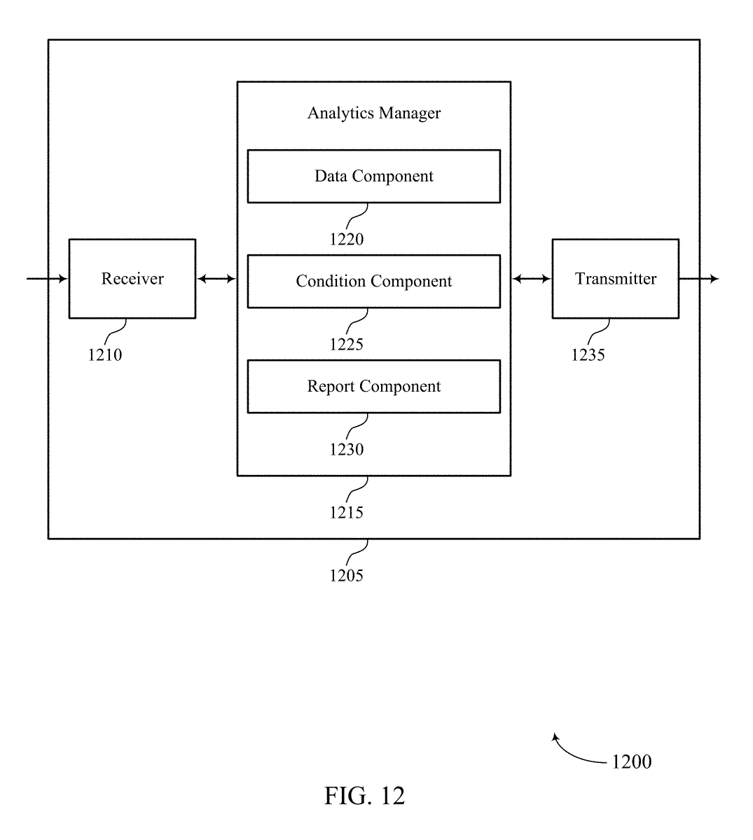

FIG. 12 shows a block diagram 1200 of a device 1205 that supports analyzing and enabling safety procedures and rules in accordance with aspects of the present disclosure. The device 1205 may be an example of aspects of a device 1105 or a device 105 as described herein. The device 1205 may include a receiver 1210, an analytics manager 1215, and a transmitter 1235. The device 1205 may also include a processor. Each of these components may be in communication with one another (e.g., via one or more buses).

The receiver 1210 may receive information such as packets, user data, or control information associated with various information channels (e.g., control channels, data channels, and information related to analyzing and enabling safety procedures and rules, etc.). Information may be passed on to other components of the device 1205. The receiver 1210 may be an example of aspects of the transceiver 1420 described with reference to FIG. 14. The receiver 1210 may utilize a single antenna or a set of antennas.

The analytics manager 1215 may be an example of aspects of the analytics manager 1115 as described herein. The analytics manager 1215 may include a data component 1220, a condition component 1225, and a report component 1230. The analytics manager 1215 may be an example of aspects of the analytics manager 1410 described herein.

The data component 1220 may receive a set of data related to an environment and a set of individuals in the environment. The condition component 1225 may determine a condition of the environment and the set of individuals in the environment based on a real-time analysis of the received set of data, where the condition includes a safety concern identified by a majority of the set of individuals. The report component 1230 may generate a real-time snapshot report based on the determining, where the real-time snapshot report includes the safety concern associated with the condition of the environment and the set of individuals in the environment and provide the real-time snapshot report for display.

The transmitter 1235 may transmit signals generated by other components of the device 1205. In some examples, the transmitter 1235 may be collocated with a receiver 1210 in a transceiver module. For example, the transmitter 1235 may be an example of aspects of the transceiver 1420 described with reference to FIG. 14. The transmitter 1235 may utilize a single antenna or a set of antennas.

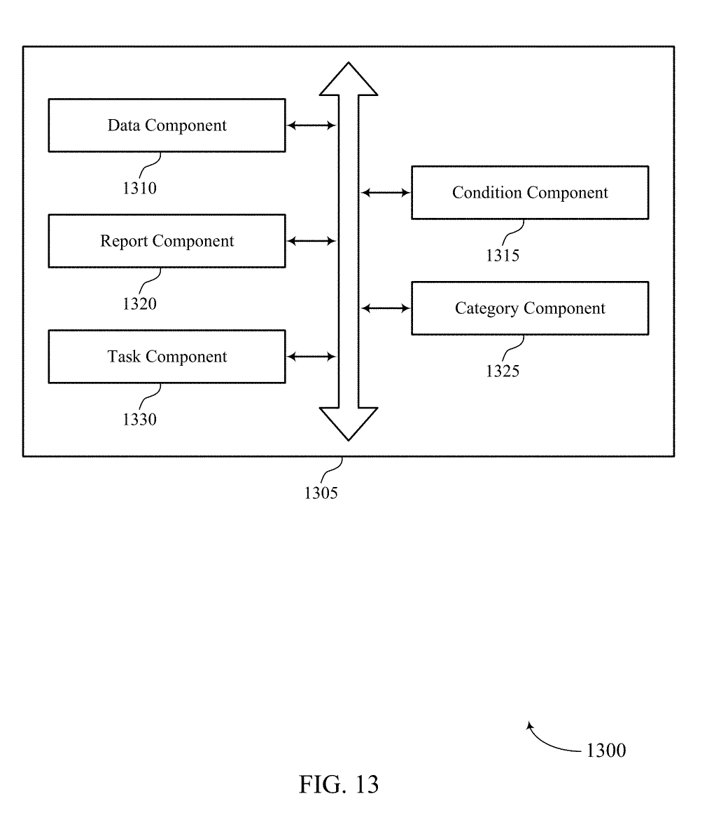

FIG. 13 shows a block diagram 1300 of a analytics manager 1305 that supports analyzing and enabling safety procedures and rules in accordance with aspects of the present disclosure. The analytics manager 1305 may be an example of aspects of a analytics manager 1115, a analytics manager 1215, or a analytics manager 1410 described herein. The analytics manager 1305 may include a data component 1310, a condition component 1315, a report component 1320, a category component 1325, and a task component 1330. Each of these modules may communicate, directly or indirectly, with one another (e.g., via one or more buses).

The data component 1310 may receive a set of data related to an environment and a set of individuals in the environment. In some examples, data component 1310 may receive user-defined safety data including potential safety hazards related to the individual or the set of individuals or within the environment, where receiving the set of data related to the environment and the set of individuals in the environment includes receiving the user-defined safety data. In some examples, data component 1310 may receive, from a sensor wearable by an individual of the set of individuals, sensor data including environmental information associated with the environment or biometric information associated with the individual of the set of individuals, where receiving the set of data related to the environment and the set of individuals in the environment includes receiving the environmental information associated with the environment or the biometric information associated with the individual of the set of individuals. In some cases, the sensor includes a camera, a wearable biometric sensor, or a temperature sensor, or a combination thereof. In some cases, the biometric information associated with the individual in the environment includes: a blood pressure of the individual, a temperature of the individual, a heart rate and rhythm of the individual, a breathing pattern of the individual, or any combination thereof and the environmental information associated with the environment includes a physical condition of the environment, a physical condition of the individual, a chemical condition of the environment, an ergonomic condition of the environment, or a radiation condition of the environment, or any combination thereof. In some cases, the environment includes a worksite. In some cases, the set of data related to the environment and the set of individuals in the environment is user-defined.

The condition component 1315 may determine a condition of the environment and the set of individuals in the environment based on a real-time analysis of the received set of data, where the condition includes a safety concern identified by a majority of the set of individuals. In some examples, the condition component 1315 may identify a set of hazards associated with the work task allocation based on the set of data and the identified certification level associated with the work task and the certification level of each individual of the set of individuals, where determining the safety concern is further based on the identified set of hazards.

The report component 1320 may generate a real-time snapshot report based on the determining, where the real-time snapshot report includes the safety concern associated with the condition of the environment and the set of individuals in the environment. In some examples, the report component 1320 may provide the real-time snapshot report for display. In some examples, the report component 1320 may identify an administrator associated with the environment. In some examples, the report component 1320 may transmit, to the administrator or the set of individuals in the environment, or both, a message including the real-time snapshot report and instructions to prevent the safety concern, where the instructions include a micro-learning lesson for preventing the safety concern. The report component 1320 may include in the message a video or a transcript associated with the micro-learning lesson. In some examples, the report component 1320 may include in the message a uniform resource locator link associated with the micro-learning lesson, where the uniform resource locator link directs the administrator to a third-party website for additional information associated with preventing the safety concern.

The report component 1320 may receive, from the administrator or the set of individuals in the environment, or both, a second message acknowledging the real-time snapshot report and the instructions to prevent the safety concern, where reception of the second message enables the administrator to authorize one or more work tasks for the set of individuals in the environment or enables the set of individuals to perform the one or more work tasks. In some examples, the report component 1320 may distribute a set of messages to the set of individuals in the environment in accordance with a pairing scheme, where each message of the set of messages corresponds to an individual of the set of individuals, and the message further including a safety concern identified by the individual and an indication of the safety concern among the set of individuals.

The report component 1320 may generate a list of instructions and preventative topics available for micro-learning and corresponding to a work task allocation for each individual of the set of individuals in the environment based on the received set of data and a set of historic data associated with the environment. In some examples, the report component 1320 may transmit to a device associated with each individual of the set of individuals the list of instructions and preventative topics available for micro-learning. The report component 1320 may receive, from each individual of the set of individuals, a message acknowledging the list of preventative topics available for micro-learning to prevent the safety concern, where reception of the message enables the set of individuals to perform a work task allocation.

The category component 1325 may identify a category of the environment. In some examples, the category component 1325 may identify a set of hazards associated with the category of the environment based on the set of data, where determining the safety concern is further based on the identified set of hazards. The task component 1330 may identify a work task allocation for each individual of the set of individuals. In some examples, the task component 1330 may identify a certification level associated with the work task allocation and a certification level of each individual of the set of individuals.

FIG. 14 shows a diagram of a system 1400 including a device 1405 that supports analyzing and enabling safety procedures and rules in accordance with aspects of the present disclosure. The device 1405 may be an example of or include the components of device 1105, device 1205, or a device as described herein. The device 1405 may include components for bi-directional voice and data communications including components for transmitting and receiving communications, including an analytics manager 1410, an I/O controller 1415, a transceiver 1420, an antenna 1425, memory 1430, and a processor 1440. These components may be in electronic communication via one or more buses (e.g., bus 1445).

The analytics manager 1410 may receive a set of data related to an environment and a set of individuals in the environment, determine a condition of the environment and the set of individuals in the environment based on a real-time analysis of the received set of data, where the condition includes a safety concern identified by a majority of the set of individuals, generate a real-time snapshot report based on the determining, where the real-time snapshot report includes the safety concern associated with the condition of the environment and the set of individuals in the environment, and provide the real-time snapshot report for display.

The I/O controller 1415 may manage input and output signals for the device 1405. The I/O controller 1415 may also manage peripherals not integrated into the device 1405. In some cases, the I/O controller 1415 may represent a physical connection or port to an external peripheral. In some cases, the I/O controller 1415 may utilize an operating system such as iOS, ANDROID, MS-DOS, MS-WINDOWS, OS/2, UNIX, LINUX, or another known operating system. In other cases, the I/O controller 1415 may represent or interact with a modem, a keyboard, a mouse, a touchscreen, or a similar device. In some cases, the I/O controller 1415 may be implemented as part of a processor. In some cases, a user may interact with the device 1405 via the I/O controller 1415 or via hardware components controlled by the I/O controller 1415. In some examples, the I/O controller 1415 may include one or more sensors (e.g., biometric sensors, environmental sensors as described herein).

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas. In some cases, the device 1405 may include a single antenna 1425. However, in some cases the device 1405 may have more than one antenna 1425, which may be capable of concurrently transmitting or receiving multiple wireless transmissions.

The memory 1430 may include RAM and ROM. The memory 1430 may store computer-readable, computer-executable code 1435 including instructions that, when executed, cause the processor to perform various functions described herein. In some cases, the memory 1430 may contain, among other things, a BIOS which may control basic hardware or software operation such as the interaction with peripheral components or devices.

The code 1435 may include instructions to implement aspects of the present disclosure, including instructions to support real-time analytics. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting analyzing and enabling safety procedures and rules).

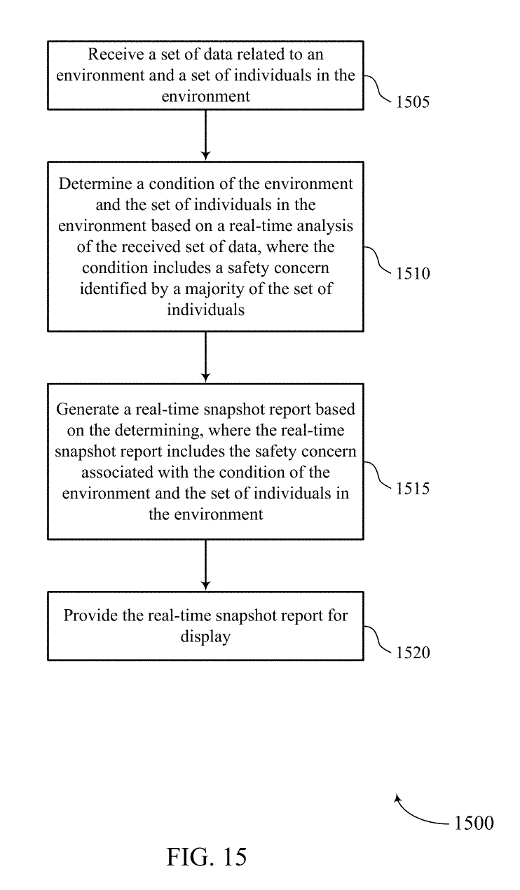

FIG. 15 shows a flowchart illustrating a method 1500 that supports analyzing and enabling safety procedures and rules in accordance with aspects of the present disclosure. The operations of method 1500 may be implemented by a device or its components as described herein. For example, the operations of method 1500 may be performed by a analytics manager as described with reference to FIGS. 11 through 14. In some examples, a device may execute a set of instructions to control the functional elements of the device to perform the functions described below. Additionally or alternatively, a device may perform aspects of the functions described below using special-purpose hardware.

At 1505, the device may receive a set of data related to an environment and a set of individuals in the environment. The operations of 1505 may be performed according to the methods described herein. In some examples, aspects of the operations of 1505 may be performed by a data component as described with reference to FIGS. 11 through 14.

At 1510, the device may determine a condition of the environment and the set of individuals in the environment based on a real-time analysis of the received set of data, where the condition includes a safety concern identified by a majority of the set of individuals. The operations of 1510 may be performed according to the methods described herein. In some examples, aspects of the operations of 1510 may be performed by a condition component as described with reference to FIGS. 11 through 14.

At 1515, the device may generate a real-time snapshot report based on the determining, where the real-time snapshot report includes the safety concern associated with the condition of the environment and the set of individuals in the environment. The operations of 1515 may be performed according to the methods described herein. In some examples, aspects of the operations of 1515 may be performed by a report component as described with reference to FIGS. 11 through 14.

At 1520, the device may provide the real-time snapshot report for display. The operations of 1520 may be performed according to the methods described herein. In some examples, aspects of the operations of 1520 may be performed by a report component as described with reference to FIGS. 11 through 14.

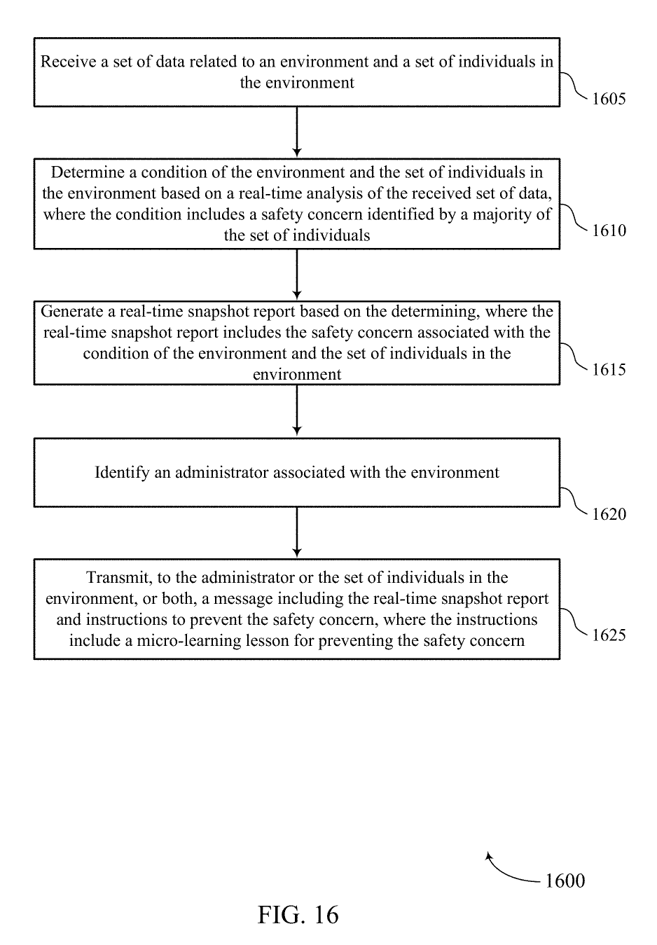

FIG. 16 shows a flowchart illustrating a method 1600 that supports analyzing and enabling safety procedures and rules in accordance with aspects of the present disclosure. The operations of method 1600 may be implemented by a device or its components as described herein. For example, the operations of method 1600 may be performed by a analytics manager as described with reference to FIGS. 11 through 14. In some examples, a device may execute a set of instructions to control the functional elements of the device to perform the functions described below. Additionally or alternatively, a device may perform aspects of the functions described below using special-purpose hardware.

At 1605, the device may receive a set of data related to an environment and a set of individuals in the environment. The operations of 1605 may be performed according to the methods described herein. In some examples, aspects of the operations of 1605 may be performed by a data component as described with reference to FIGS. 11 through 14.

At 1610, the device may determine a condition of the environment and the set of individuals in the environment based on a real-time analysis of the received set of data, where the condition includes a safety concern identified by a majority of the set of individuals. The operations of 1610 may be performed according to the methods described herein. In some examples, aspects of the operations of 1610 may be performed by a condition component as described with reference to FIGS. 11 through 14.

At 1615, the device may generate a real-time snapshot report based on the determining, where the real-time snapshot report includes the safety concern associated with the condition of the environment and the set of individuals in the environment. The operations of 1615 may be performed according to the methods described herein. In some examples, aspects of the operations of 1615 may be performed by a report component as described with reference to FIGS. 11 through 14.

At 1620, the device may identify an administrator associated with the environment. The operations of 1620 may be performed according to the methods described herein. In some examples, aspects of the operations of 1620 may be performed by a report component as described with reference to FIGS. 11 through 14.

At 1625, the device may transmit, to the administrator or the set of individuals in the environment, or both, a message including the real-time snapshot report and instructions to prevent the safety concern, where the instructions include a micro-learning lesson for preventing the safety concern. The operations of 1625 may be performed according to the methods described herein. In some examples, aspects of the operations of 1625 may be performed by a report component as described with reference to FIGS. 11 through 14.

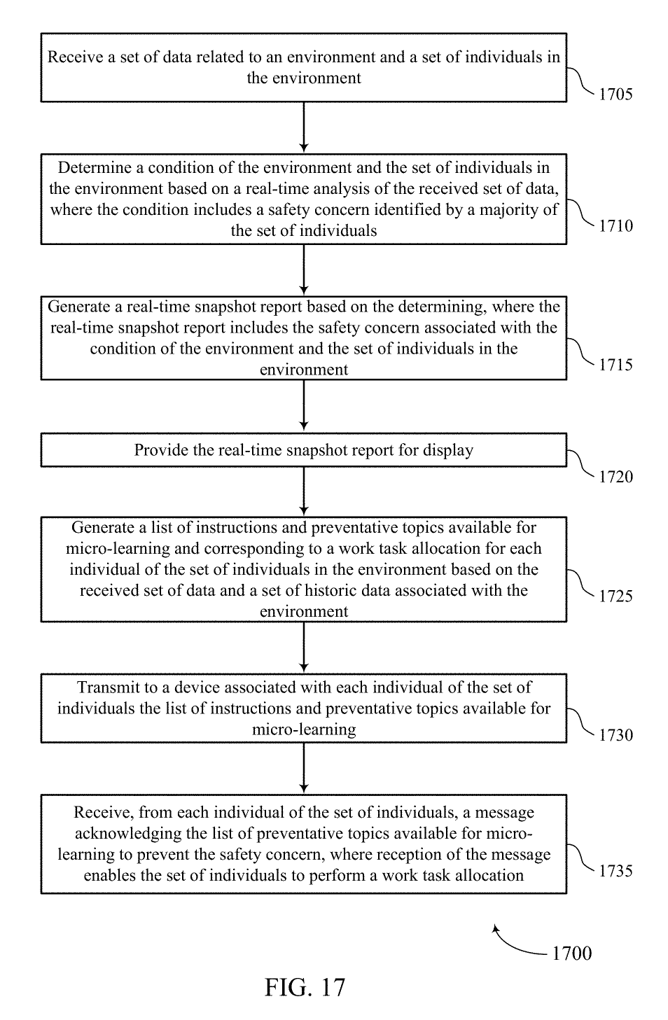

FIG. 17 shows a flowchart illustrating a method 1700 that supports analyzing and enabling safety procedures and rules in accordance with aspects of the present disclosure. The operations of method 1700 may be implemented by a device or its components as described herein. For example, the operations of method 1700 may be performed by a analytics manager as described with reference to FIGS. 11 through 14. In some examples, a device may execute a set of instructions to control the functional elements of the device to perform the functions described below. Additionally or alternatively, a device may perform aspects of the functions described below using special-purpose hardware.

At 1705, the device may receive a set of data related to an environment and a set of individuals in the environment. The operations of 1705 may be performed according to the methods described herein. In some examples, aspects of the operations of 1705 may be performed by a data component as described with reference to FIGS. 11 through 14.

At 1710, the device may determine a condition of the environment and the set of individuals in the environment based on a real-time analysis of the received set of data, where the condition includes a safety concern identified by a majority of the set of individuals. The operations of 1710 may be performed according to the methods described herein. In some examples, aspects of the operations of 1710 may be performed by a condition component as described with reference to FIGS. 11 through 14.

At 1715, the device may generate a real-time snapshot report based on the determining, where the real-time snapshot report includes the safety concern associated with the condition of the environment and the set of individuals in the environment. The operations of 1715 may be performed according to the methods described herein. In some examples, aspects of the operations of 1715 may be performed by a report component as described with reference to FIGS. 11 through 14.

At 1720, the device may provide the real-time snapshot report for display. The operations of 1720 may be performed according to the methods described herein. In some examples, aspects of the operations of 1720 may be performed by a report component as described with reference to FIGS. 11 through 14.

At 1725, the device may generate a list of instructions and preventative topics available for micro-learning and corresponding to a work task allocation for each individual of the set of individuals in the environment based on the received set of data and a set of historic data associated with the environment. The operations of 1725 may be performed according to the methods described herein. In some examples, aspects of the operations of 1725 may be performed by a report component as described with reference to FIGS. 11 through 14.

At 1730, the device may transmit to a device associated with each individual of the set of individuals the list of instructions and preventative topics available for micro-learning. The operations of 1730 may be performed according to the methods described herein. In some examples, aspects of the operations of 1730 may be performed by a report component as described with reference to FIGS. 11 through 14.

At 1735, the device may receive, from each individual of the set of individuals, a message acknowledging the list of preventative topics available for micro-learning to prevent the safety concern, where reception of the message enables the set of individuals to perform a work task allocation. The operations of 1735 may be performed according to the methods described herein. In some examples, aspects of the operations of 1735 may be performed by a report component as described with reference to FIGS. 11 through 14.

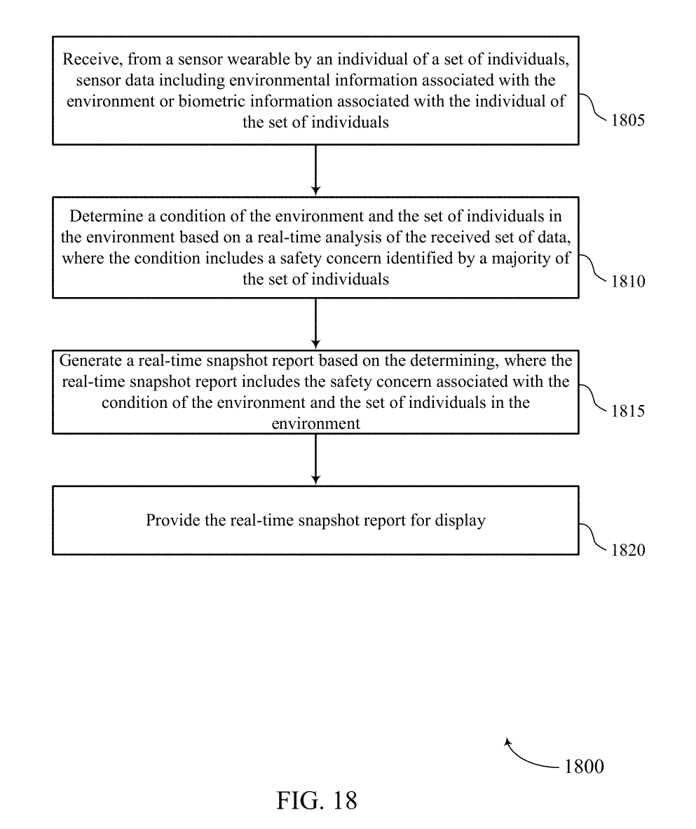

FIG. 18 shows a flowchart illustrating a method 1800 that supports analyzing and enabling safety procedures and rules in accordance with aspects of the present disclosure. The operations of method 1800 may be implemented by a device or its components as described herein. For example, the operations of method 1800 may be performed by a analytics manager as described with reference to FIGS. 11 through 14. In some examples, a device may execute a set of instructions to control the functional elements of the device to perform the functions described below. Additionally or alternatively, a device may perform aspects of the functions described below using special-purpose hardware.

At 1805, the device may receive, from a sensor wearable by an individual of a set of individuals, sensor data including environmental information associated with an environment or biometric information associated with the individual of the set of individuals. The operations of 1805 may be performed according to the methods described herein. In some examples, aspects of the operations of 1805 may be performed by a data component as described with reference to FIGS. 11 through 14.

At 1810, the device may determine a condition of the environment and the set of individuals in the environment based on a real-time analysis of the sensor data, where the condition includes a safety concern identified by a majority of the set of individuals. The operations of 1810 may be performed according to the methods described herein. In some examples, aspects of the operations of 1810 may be performed by a condition component as described with reference to FIGS. 11 through 14.

At 1815, the device may generate a real-time snapshot report based on the determining, where the real-time snapshot report includes the safety concern associated with the condition of the environment and the set of individuals in the environment. The operations of 1815 may be performed according to the methods described herein. In some examples, aspects of the operations of 1815 may be performed by a report component as described with reference to FIGS. 11 through 14.

At 1820, the device may provide the real-time snapshot report for display. The operations of 1820 may be performed according to the methods described herein. In some examples, aspects of the operations of 1820 may be performed by a report component as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The software application described herein may be developed using Apache Cordova, an open source framework utilizing Apache Cordova and JavaScript plug-ins (including, but not limited to: cordova-plugin-camera; cordova-plug-in-file; cordova-plugin-file-transfer; cordova-plugin-geolocation; cordova-plugin-inappbrowser; cordova-plugin-media; cordova-plugin-media; cordova-plugin-media-capture; cordova-plugin-network-information; cordova-plugin-print-pdf; cordova-plugin-statusbar; cordova-plugin-whitelist; cordova-sqlite-evcore-extbuild-free; cordova-plugin-fcm; cordova-plugin-badget; dorvoda-plugin-contacts; Angular; jQuery; and Google Maps). In some embodiments, the software application described herein may be coded in any of a variety of programming languages including, but not limited to JavaScript. In some cases, Application programming interfaces (APIs), which may be sets of subroutine definitions, protocols and other tools used to develop the software applications, may be coded in, but not limited to C#.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The phrase “coupled between” may refer to an order of components in relation to each other, and may refer to an electrical coupling. In one example, a component “B” that is electrically coupled between a component “A” and a component “C” may refer to an order of components of “A-B-C” or “C-B-A” in an electrical sense. In other words, electrical signals (e.g., voltage, charge, current) may be passed from component A to component C by way of component B. A description of a component B being “coupled between” component A and component C should not necessarily be interpreted as precluding other intervening components in the described order. For example, a component “D” may be coupled between the described component A and component B (e.g., referring to an order of components of “A-D-B-C” or “C-B-D-A” as examples), while still supporting component B being electrically coupled between component A and component C. In other words, the use of the phrase “coupled between” should not be construed as necessarily referencing an exclusive sequential order. Further, a description of component B being “coupled between” component A and component C does not preclude a second, different coupling between component A and component C. For example, component A and component C may be coupled with each other in a separate coupling that is electrically parallel with a coupling via component B. In another example, component A and component C may be coupled via another component “E” (e.g., component B being coupled between component A and component C and component E being coupled between component A and component C). In other words, the use of the phrase “coupled between” should not be construed as an exclusive coupling between components.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for real-time analytics, the method being performed by one or more computing devices comprising at least one processor, the method comprising:
receiving a set of data related to an environment and a set of individuals in the environment;
determining a condition of the environment and the set of individuals in the environment based at least in part on a real-time analysis of the received set of data, wherein the condition comprises a safety concern identified by a majority of the set of individuals;
generating a real-time snapshot report based at least in part on the determining, wherein the real-time snapshot report comprises the safety concern associated with the condition of the environment and the set of individuals in the environment; and
providing the real-time snapshot report for display.

2. The method of claim 1, further comprising:
identifying a category of the environment; and
identifying a set of hazards associated with the category of the environment based at least in part on the set of data,
wherein determining the safety concern is further based at least in part on the identified set of hazards.

3. The method of claim 1, further comprising:
identifying a work task allocation for each individual of the set of individuals;
identifying a certification level associated with the work task allocation and a certification level of each individual of the set of individuals; and
identifying a set of hazards associated with the work task allocation based at least in part on the set of data and the identified certification level associated with the work task and the certification level of each individual of the set of individuals,
wherein determining the safety concern is further based at least in part on the identified set of hazards.

4. The method of claim 1, further comprising:
identifying an administrator associated with the environment; and
transmitting, to the administrator or the set of individuals in the environment, or both, a message comprising the real-time snapshot report and instructions to prevent the safety concern,
wherein the instructions comprise a micro-learning lesson for preventing the safety concern.

5. The method of claim 4, further comprising:
including in the message a video or a transcript associated with the micro-learning lesson.

6. The method of claim 4, further comprising:
including in the message a uniform resource locator link associated with the micro-learning lesson,
wherein the uniform resource locator link directs the administrator to a third-party website for additional information associated with preventing the safety concern.

7. The method of claim 4, further comprising:
receiving, from the administrator or the set of individuals in the environment, or both, a second message acknowledging the real-time snapshot report and the instructions to prevent the safety concern,
wherein reception of the second message enables the administrator to authorize one or more work tasks for the set of individuals in the environment or enables the set of individuals to perform the one or more work tasks.

8. The method of claim 4, further comprising:
distributing a set of messages to the set of individuals in the environment in accordance with a pairing scheme, wherein each message of the set of messages corresponds to an individual of the set of individuals, and the message further comprising a safety concern identified by the individual and an indication of the safety concern among the set of individuals.

9. The method of claim 1, further comprising:
generating a list of instructions and preventative topics available for micro-learning and corresponding to a work task allocation for each individual of the set of individuals in the environment based at least in part on the received set of data and a set of historic data associated with the environment; and
transmitting to a device associated with each individual of the set of individuals the list of instructions and preventative topics available for micro-learning.

10. The method of claim 9, further comprising:
receiving, from each individual of the set of individuals, a message acknowledging the list of preventative topics available for micro-learning to prevent the safety concern, wherein reception of the message enables the set of individuals to perform a work task allocation.

11. The method of claim 1, further comprising:
receiving, from a sensor wearable by an individual of the set of individuals, sensor data comprising environmental information associated with the environment or biometric information associated with the individual of the set of individuals,
wherein receiving the set of data related to the environment and the set of individuals in the environment comprises receiving the environmental information associated with the environment or the biometric information associated with the individual of the set of individuals.

12. The method of claim 11, wherein the sensor comprises a camera, a wearable biometric sensor, or a temperature sensor, or a combination thereof.

13. The method of claim 11, wherein the biometric information and the environmental information associated with the individual in the environment comprises:
a blood pressure of the individual, a temperature of the individual, a heart rate and rhythm of the individual, a breathing pattern of the individual, or any combination thereof; and
the environmental information associated with the environment comprises a physical condition of the environment, a physical condition of the individual, a chemical condition of the environment, an ergonomic condition of the environment, or a radiation condition of the environment, or any combination thereof.

14. The method of claim 1, further comprising:
receiving user-defined safety data comprising potential safety hazards related to the individual or the set of individuals or within the environment, wherein receiving the set of data related to the environment and the set of individuals in the environment comprises receiving the user-defined safety data.

15. The method of claim 1, wherein the environment comprises a worksite.

16. The method of claim 1, wherein the set of data related to the environment and the set of individuals in the environment is user-defined.

17. An apparatus for real-time analytics, the method:
a processor,
memory in electronic communication with the processor; and
instructions stored in the memory and executable by the processor to cause the apparatus to:
receive a set of data related to an environment and a set of individuals in the environment;
determine a condition of the environment and the set of individuals in the environment based at least in part on a real-time analysis of the received set of data, wherein the condition comprises a safety concern identified by a majority of the set of individuals;
generate a real-time snapshot report based at least in part on the determining, wherein the real-time snapshot report comprises the safety concern associated with the condition of the environment and the set of individuals in the environment; and
provide the real-time snapshot report for display.

18. The apparatus of claim 17, wherein the instructions are further executable by the processor to cause the apparatus to:
identify a category of the environment; and
identify a set of hazards associated with the category of the environment based at least in part on the set of data, wherein determining the safety concern is further based at least in part on the identified set of hazards.

19. A non-transitory computer-readable medium storing code for real-time analytics, the method being performed by one or more computing devices comprising at least one processor, the method comprising, the code comprising instructions executable by a processor to:
receive a set of data related to an environment and a set of individuals in the environment;
determine a condition of the environment and the set of individuals in the environment based at least in part on a real-time analysis of the received set of data, wherein the condition comprises a safety concern identified by a majority of the set of individuals;
generate a real-time snapshot report based at least in part on the determining, wherein the real-time snapshot report comprises the safety concern associated with the condition of the environment and the set of individuals in the environment; and
provide the real-time snapshot report for display.

20. The non-transitory computer-readable medium of claim 19, wherein the instructions are further executable to:
identify a category of the environment; and
identify a set of hazards associated with the category of the environment based at least in part on the set of data, wherein determining the safety concern is further based at least in part on the identified set of hazards.
